(19) United States
(12) Patent Application Publication
(10) Pub. No.: US 2014/0348357 A1
(43) Pub. Date: Nov. 27, 2014

(54) Sound Effect Adjustment Method, Apparatus and Device

(71) Applicant: Huawei Technologies Co., Ltd., Shenzhen (CN)

(72) Inventor: Junbin Liang, Shenzhen (CN)

(21) Appl. No.: 14/457,409

(22) Filed: Aug. 12, 2014

Related U.S. Application Data
(63) Continuation of application No. PCT/CN2013/084140, filed on Sep. 25, 2013.

(30) Foreign Application Priority Data
Apr. 23, 2013 (CN) 201310142961.1

(51) Int. Cl. H04S 7/00

(52) U.S. Cl. CPC H04S 7/305
USPC 381/303

(57) ABSTRACT

A sound effect adjustment method, apparatus and system are provided that are applicable to the sound box field. The method includes: detecting the number of connected sound boxes, a sound box orientation angle, and a distance between a sound box and a listener; selecting a corresponding sound field model; loading the distance between the sound box and the listener and the sound box orientation angle, and adjusting a sound field transmission function; and adjusting a digital audio signal and outputting the adjusted digital audio signal. In the embodiments of the present invention, the sound field transmission function of the sound box can be specifically adjusted according to the position of the listener, so that the sound box can be more adaptive to the specific number of sound playing apparatuses and the position of the listener, the acoustic effects are further improved, and higher adaptability is achieved.

### CROSS-REFERENCE TO RELATED APPLICATIONS

This application is a continuation of International Application No. PCT/CN2013/084140 filed on Sep. 25, 2013, which claims priority to Chinese Patent Application No. 201310142961.1, filed on Apr. 23, 2013, both of which are hereby incorporated by reference in their entireties.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates to a sound box field, and in particular, to a sound effect adjustment method, apparatus and device.

### BACKGROUND

A conventional sound playing apparatus primarily includes a sound box and a sound box adaptation apparatus. The sound box is connected to the sound box adaptation apparatus. After being input into the sound box adaptation apparatus, source sound data or signals undergo digital signal processing, and finally, digital audio signals are converted into analog audio signals and output to the sound box, so that electrical signals are converted into sound signals.

Important indicators of acoustic effects of a sound playing apparatus include stereophony, orientation, spatiality, distortion, bass, treble, and so on. The stereophony refers to stereophonic sound. If an entire system can recover original spatiality to some extent from recording to playback, the playback sound that takes on some extent of spatial distribution features such as orientation levels is called stereophony in acoustic technologies. A sound playing apparatus of good stereophony can improve information clarity and comprehensibility and enhance an on-site sense of a listener.

To impart a better audio effect to the listener in the prior art, shape parameters of a space that accommodates the sound playing apparatus and a reverberation time are obtained, a corresponding digital signal optimization algorithm is determined for optimization according to the obtained shape parameters, and then the optimized digital audio signals are output, thereby achieving a good play effect in a specific space. However, as affected by factors such as orientation of the sound playing apparatus and the location of the listener, better acoustic effects are hardly achievable in a specific scene.

### SUMMARY

Embodiments of the present invention aim to provide a sound effect adjustment method to solve the problem in the prior art that a listener's acoustic effects are deteriorated by factors such as positions of a sound playing apparatus and the listener, so as to further improve the acoustic effects and achieve higher adaptability.

To achieve the foregoing objectives, the embodiments of the present invention provide the following technical solutions:

A first aspect of the present invention provides a sound effect adjustment method, where the method includes: detecting the number of connected sound boxes, a sound box orientation angle, and a distance between a sound box and a listener; selecting a corresponding sound field model according to the number of connected sound boxes; loading the distance between the sound box and the listener and the sound box orientation angle according to the sound field model, and adjusting a sound field transmission function; and adjusting a digital audio signal according to the sound field transmission function and output the adjusted digital audio signal.

In a first possible implementation manner of the first aspect, the method further includes: detecting a reverberation time of an ambient space; determining whether the detected reverberation time of the ambient space falls within a preset duration interval; and decreasing or increasing a reverberation time parameter value in the sound field transmission function if the detected reverberation time of the ambient space does not fall within the preset duration interval.

With reference to the first possible implementation manner of the first aspect of the present invention, in a second possible implementation manner, the step of detecting a reverberation time of an ambient space specifically includes: outputting an audio signal of a specific band; determining whether a sound field formed by the sound box is steady according to a sound signal received by a sound receiving module that is set on the sound box; cutting off the sound signal of the sound box if the sound field is steady; obtaining, according to a sound pressure signal received by the sound receiving module, a time required for decreasing the sound pressure signal to a preset sound pressure threshold; determining whether all preset bands are tested, and, if not, continuing to test a next band; and averaging multiple obtained times to obtain a reverberation time of the ambient space.

With reference to the second possible implementation manner of the first aspect of the present invention, in a third possible implementation manner, the preset sound pressure threshold is 60 decibels (dB).

In a fourth possible implementation manner of the first aspect of the present invention, the step of detecting the number of sound connected boxes specifically includes: outputting an audio analog signal at all sound box interfaces; detecting a value of a current that is series connected in a sound box connection line and passes through a current detecting module; if the current value reaches a preset value, determining that the sound box in the connection line is available; and calculating the number of all available sound boxes.

In a fifth possible implementation manner of the first aspect of the present invention, the step of detecting a sound box orientation angle specifically is: obtaining, by an angle detecting module that is set on each sound box and oriented toward the same direction as an opening direction of the sound box, data of the sound box orientation angle.

In a sixth possible implementation manner of the first aspect of the present invention, the step of detecting a distance between a sound box and a listener specifically includes: recording a sound wave or ultrasonic wave signal sent by the listener and received by a sound receiving module that is set on each sound box, and recording a transmission time; and obtaining the distance between the listener and the sound box according to the time at which the sound wave or ultrasonic wave is received.

In a seventh possible implementation manner of the first aspect of the present invention, the step of detecting a distance between a sound box and a listener specifically includes: obtaining data of the distance between the listener and the sound box in real time, where the data is received by an infrared rangefinder that is set on a sound box device; sending the obtained distance data to an output device; and receiving distance information confirmed by the listener or distance information selected by the listener.

In an eighth possible implementation manner of the first aspect of the present invention, the method further includes: receiving an audio signal that is input by a microphone on which position information is set; and obtaining position information of the sound box, where the step of loading the distance between the sound box and the listener and the sound box orientation angle according to the sound field model and adjusting a sound field transmission function specifically is adjusting the sound field transmission function according to position information of the microphone.

A second aspect of the present invention provides a sound effect adjustment apparatus, where the apparatus includes: a first detecting unit configured to detect the number of connected sound boxes, a sound box orientation angle, and a distance between a sound box and a listener; a selecting unit configured to select a corresponding sound field model according to the number of connected sound boxes; a loading and adjusting unit configured to load the distance between the sound box and the listener and the sound box orientation angle according to the sound field model, and adjust a sound field transmission function; and an outputting unit configured to adjust a digital audio signal according to the sound field transmission function and output the adjusted digital audio signal.

In a first possible implementation manner of the second aspect of the present invention, the apparatus further includes: a second detecting unit configured to detect a reverberation time of an ambient space; a determining unit configured to determine whether the detected reverberation time of the ambient space falls within a preset duration interval; and a reverberation time adjusting unit configured to decrease or increase a reverberation time parameter value in the sound field transmission function if the detected reverberation time of the ambient space does not fall within the preset duration interval.

With reference to the second possible implementation manner of the second aspect of the present invention, in a third possible implementation manner, the second detecting unit specifically includes: an audio signal outputting subunit configured to output an audio signal of a specific band; a sound field steadiness determining subunit configured to determine whether a sound field formed by the sound box is steady according to a received sound signal; a sound signal cutoff subunit configured to cut off the sound signal of the sound box if the sound field is steady; an obtaining subunit configured to obtain, according to a sound pressure signal received by the sound receiving module, a time required for decreasing the sound pressure signal to a preset sound pressure threshold; a first determining subunit configured to determine whether all preset bands are tested, and, if not, continue to test a next band; and a reverberation time obtaining subunit configured to average multiple obtained times to obtain a reverberation time of the ambient space.

With reference to the third possible implementation manner of the second aspect of the present invention, in a fourth possible implementation manner of the second aspect of the present invention, the preset sound pressure threshold is 60 dB.

In a fourth possible implementation manner of the second aspect of the present invention, the detecting unit includes: an audio analog signal outputting subunit configured to output an audio analog signal at all sound box interfaces; a current value detecting subunit configured to detect a value of a current that is series connected in a sound box connection line and passes through a current detecting module; a sound box determining subunit configured to: if the current value reaches a preset value, determine that the sound box in the connection line is available; and a sound box quantity calculating subunit configured to calculate the number of all available sound boxes.

In a fifth possible implementation manner of the second aspect of the present invention, the detecting unit includes: a receiving time recording subunit configured to record a sound wave or ultrasonic wave signal sent by the listener and received by a sound receiving module that is set on each sound box, and record a transmission time; and a first distance obtaining subunit configured to obtain the distance between the listener and the sound box according to the time at which the sound wave or ultrasonic wave is received.

In a sixth possible implementation manner of the second aspect of the present invention, the detecting unit includes: a second distance obtaining subunit configured to obtain data of the distance between the listener and the sound box in real time, where the data is received by an infrared rangefinder that is set on a sound box device; a distance data sending subunit configured to send the obtained distance data to an output device; and an information receiving subunit configured to receive distance information confirmed by the listener or distance information selected by the listener.

In a seventh possible implementation manner of the second aspect of the present invention, the apparatus further includes: an audio signal receiving unit configured to receive an audio signal that is input by a microphone on which position information is set; and a position information obtaining unit configured to obtain position information of the sound box, where the loading and adjusting unit is specifically configured to adjust the sound field transmission function according to position information of the microphone.

A third aspect of the present invention provides a sound effect adjustment system, where the system includes: a sound box apparatus, where a current detecting module, an angle detecting module, and an infrared rangefinder are set on the sound box apparatus to detect a current signal that flows through a sound box, detect an angle signal of the sound box, and detect a distance signal of a listener, respectively; and a sound box adaptation apparatus configured to: receive the current signal, the angle signal of the sound box, and the distance signal of the listener, calculate the number of corresponding connected sound boxes, a sound box orientation angle, and the distance between the sound box and the listener, select a corresponding sound field model according to the number of connected sound boxes, load the distance between the sound box and the listener and the sound box orientation angle according to the sound field model and adjust a sound field transmission function, and adjust a digital audio signal according to the sound field transmission function and output the adjusted digital audio signal.

In a first possible implementation manner of the third aspect of the present invention, the sound box apparatus further includes a sound receiving module configured to receive a sound signal; and the sound box adaptation apparatus is configured to: output an audio signal of a specific band, receive the sound signal of the sound receiving module and determine whether a sound field formed by the sound box is steady, cut off the sound signal of the sound box if the sound field is steady, and obtain, according to a sound pressure signal received by the sound receiving module, a time required for decreasing the sound pressure signal to a preset sound pressure threshold, determine whether all preset bands are tested, and, if not, continue to test a next band, and average multiple obtained times to obtain a reverberation time of the ambient space, and decrease or increase a reverberation time parameter value in the sound field transmission function if determining that the reverberation time of the ambient space does not fall within the preset duration interval.

A fourth aspect of the present invention provides a sound effect adjustment system, where the system includes: a sound box apparatus, where a sound receiving module, a current detecting module, and an angle detecting module are set on the sound box apparatus to detect a sound signal, a current signal, and an angle signal of a sound box respectively; a remote control apparatus configured to receive a remote control instruction, and send an ultrasonic wave or a sound wave that is receivable by the sound receiving module of the sound box apparatus; and a sound box adaptation apparatus configured to receive the sound signal, the current signal, and the angle signal of the sound box, calculate a distance between a corresponding sound box and a listener, the number of connected sound boxes, and a sound box orientation angle, select a corresponding sound field model according to the number of connected sound boxes, load the distance between the sound box and the listener and the sound box orientation angle according to the sound field model and adjust a sound field transmission function, and adjust a digital audio signal according to the sound field transmission function and output the adjusted digital audio signal.

A fifth aspect of the present invention provides an acoustic device, where the acoustic device includes the sound effect adjustment system.

In the embodiments of the present invention, the number of connected sound boxes, the sound box orientation angle, and the distance between the sound box and the listener are detected, a corresponding sound field model is selected according to the number of connected sound boxes, the distance between the sound box and the listener is loaded into the sound field model, and the sound field transmission function is adjusted, and then the adjusted digital audio signal is output according to the adjusted sound field transmission function. In the embodiments of the present invention, the number of connected sound boxes and the sound box orientation angle are detected, and the sound field transmission function of the sound box can be specifically adjusted according to the position of the listener, so that the sound box can be more adaptive to the specific number of sound playing apparatuses and orientation of the sound playing apparatus and the position of the listener, the acoustic effects are further improved, and higher adaptability is achieved.

### BRIEF DESCRIPTION OF THE DRAWINGS

FIG. 1 is a flowchart of implementing sound effect adjustment according to Embodiment 1 of the present invention;

FIG. 2 is a flowchart of implementing sound effect adjustment according to Embodiment 2 of the present invention;

FIG. 3 is a schematic diagram of detecting sound box connectivity according to Embodiment 2 of the present invention;

FIG. 4 is a sound field model diagram of two sound boxes according to Embodiment 2 of the present invention;

FIG. 5 is a sound field model diagram of three sound boxes according to Embodiment 2 of the present invention;

FIG. 6 is a sound field model diagram of four sound boxes according to Embodiment 2 of the present invention;

FIG. 7 is a sound field model diagram of five sound boxes according to Embodiment 2 of the present invention;

FIG. 8 is a schematic flowchart of sound effect adjustment according to Embodiment 2 of the present invention;

FIG. 8A is a schematic diagram of detecting a reverberation time of an ambient space according to Embodiment 2 of the present invention;

FIG. 9 is a schematic structural diagram of an audio conference to which a sound effect adjustment method is applied according to Embodiment 3 of the present invention;

FIG. 10 is a sound effect adjustment system according to Embodiment 4 of the present invention;

FIG. 11 is a sound effect adjustment system according to Embodiment 5 of the present invention;

FIG. 12 is a sound effect adjustment system according to Embodiment 6 of the present invention; and

FIG. 13 is a structural block diagram of a sound effect adjustment apparatus according to Embodiment 7 of the present invention.

### DETAILED DESCRIPTION

To make the objectives, technical solutions and advantages of the present invention more comprehensible, the following describes the present invention in detail with reference to the accompanying drawings and embodiments. It should be understood that the embodiments described herein are merely for illustrating the present invention, and are not intended to limit the present invention.

In the embodiments of the present invention, a sound field model can be obtained according to the number of connected sound boxes and a sound box orientation angle, a parameter of a distance between a sound box and a listener is loaded into the sound field model, and a sound field transmission function can be adjusted according to the distance so that the listener can perceive better acoustic effects. To achieve better acoustic effects, a reverberation time of an ambient space may be further measured and adjusted.

### Embodiment 1

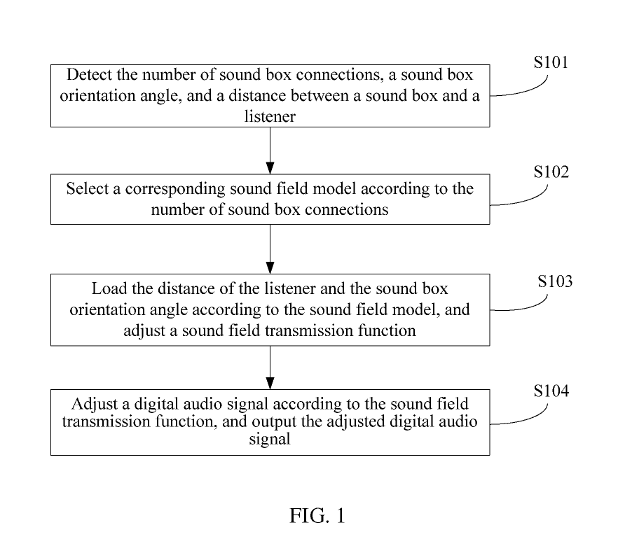

FIG. 1 shows a process of implementing a sound effect adjustment method according to the embodiment of the present invention, as detailed below:

In step S101, the number of connected sound boxes, a sound box orientation angle, and a distance between a sound box and a listener are detected.

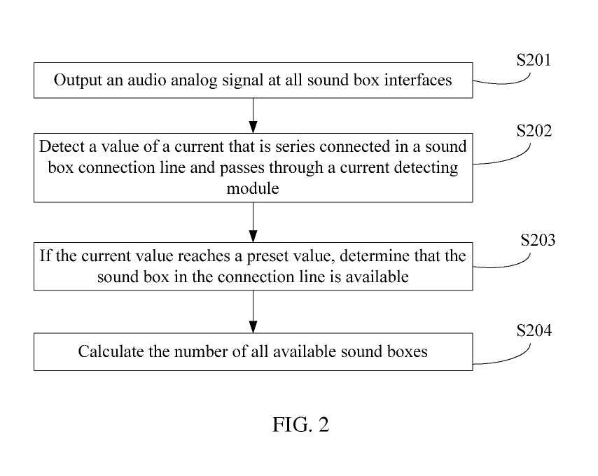

Specifically, depending on conditions on the site or line faults, the number of actually working sound boxes is sometimes different from the number of sound boxes connected in a sound box system. In this case, the number of sound boxes connected to a sound box adaptation apparatus needs to be detected. The manner shown in FIG. 2 may be applied:

In step S201, an audio analog signal is output at all sound box interfaces.

Specifically, N sound box interfaces are set on the sound box adaptation apparatus, and an audio analog signal is output on each sound box interface, that is, a corresponding level signal is output to each sound box. To ensure reliability of the detection, a relatively constant audio signal is selected as the output audio analog signal, so as to prevent bass and treble from leading to inaccurate detection results.

In step S202, a value of a current that is series connected in a sound box connection line and passes through a current detecting module is detected.

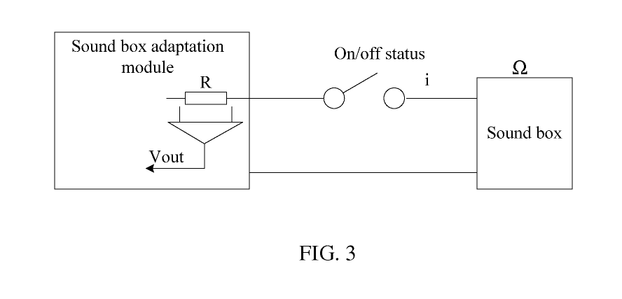

As shown in FIG. 3, the current detecting module may be a resistor R that is series connected in a line, and can measure voltage in the resistor in parallel. When a sound box is connected, a corresponding current flows through the resistor R, and a certain voltage drop occurs in the resistor R. By detecting the change of a voltage value, the value of the current that passes through the resistor R is obtained correspondingly. Conversely, when the sound box is disconnected, the current that passes through the resistor R is 0, and the corresponding voltage drop is zero.

In step S203, if the current value reaches a preset value, it is determined that the sound box in the connection line is available.

To eliminate the impact caused by an interfering signal onto the detection result, a preset current value is set. If the detected current value is greater than the preset value, it is determined that the sound box in the connection line is normally connected and available.

In step S204, the number of all available sound boxes is calculated.

When values returned by multiple current detecting modules are received, the returned data are collected to obtain the number of currently available sound boxes.

FIG. 2 shows one possible implementation manner. Another practice is that an audio signal is output in each sound box, and a sound receiving module (such as a microphone) measures normal connectivity of the sound box. If the microphone returns a signal value, it is determined that the sound box is connected normally. To ensure validity of the measurement, noise interference should be avoided in the test environment as far as possible.

In detecting the sound box orientation angle, an angle detecting module that is set on each sound box and oriented toward the same direction as the opening direction of the sound box may obtain data of the sound box orientation angle, where the angle detecting module may be an electronic compass or another electronic angle indication component. The angle detecting module can measure the current sound box orientation angle. In a wired or wireless data transmission manner, the angle data obtained by the angle detecting module is output to the sound box adaptation apparatus, and is used to adjust the sound field transmission function and create a sound field model.

The distance between a sound box and a listener may be detected in either of the following two manners:

Manner 1:

1.1. Record a sound wave or ultrasonic wave signal sent by the listener and received by a sound receiving module that is set on each sound box, and record a transmission time.

Specifically, the sound receiving module may be a microphone or another sound wave receiving apparatus, and the listener sends a sound wave or an ultrasonic wave. The listener may send the wave by using a sound wave sending apparatus. To record a transmission time of the sound wave or ultrasonic wave from the listener to each sound box, an infrared signal may be sent to the sound box adaptation apparatus at the same time of sending the ultrasonic wave or sound wave signal so that the sending time of the sound wave or ultrasonic wave is obtained. A time difference between the receiving time and the sending time is the signal transmission time of the sound wave or ultrasonic wave.

1.2. Obtain the distance between the listener and the sound box according to the time at which the sound wave or ultrasonic wave is received.

After the transmission time of the sound wave or ultrasonic wave is obtained, the distance between the listener and the sound box can be obtained, and the distance between the sound box and each sound box is recorded respectively.

Manner 2:

2.1. Obtain data of the distance between the listener and the sound box in real time, where the data is received by an infrared rangefinder that is set on a sound box device.

Specifically, the distance data obtained by the infrared rangefinder is the distance between the listener and the sound box on which the infrared rangefinder is located. To facilitate recording of the data of each sound box, all sound boxes are numbered. All devices that are set on the sound box, such as the infrared rangefinder, the sound receiving module, and the angle detecting module, have serial number information corresponding to the serial number of the sound box on which the devices are located.

Further, preferably, steps 2.2 and 2.3 may be further included, where step 2.2 is to send the obtained distance data to an output device.

The distance data obtained by the infrared rangefinder is output by an output device such as a display screen. Further, preferably, position data of the sound box may be obtained, and the position data of the sound box and the listener is displayed in the form of a plane chart, so that the listener obtains more vivid and more intuitive display data.

2.3. Receive distance information confirmed by the listener or distance information selected by the listener.

The listener may send a confirmation instruction, or, if multiple pieces of position or distance information are available for selecting, one of the pieces of position information is confirmed. By means of the confirmation, the accuracy of the distance between the listener and the sound box can be further improved.

In step S102, a corresponding sound field model is selected according to the number of connected sound boxes.

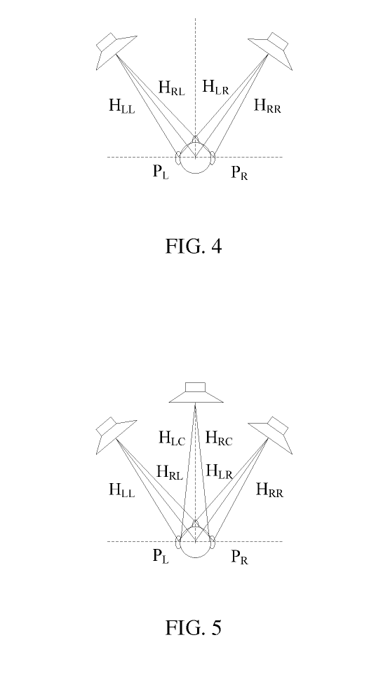

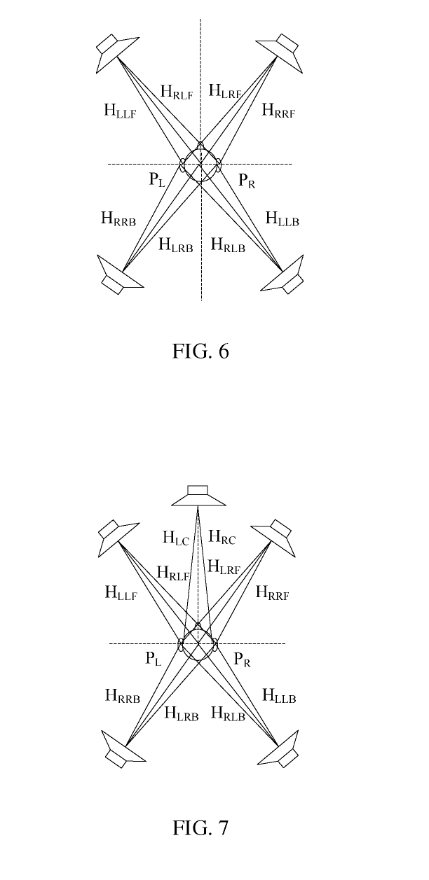

Specifically, the corresponding sound field model can be obtained according to the detected number of connected sound boxes. FIG. 4, FIG. 5, FIG. 6, and FIG. 7 show the sound field models with 2, 3, 4, and 5 sound boxes respectively.

In step S103, the distance between the sound box and the listener and the sound box orientation angle are loaded according to the sound field model, and a sound field transmission function is adjusted.

The orientation angle of each sound box is a geometric center formed by multiple sound boxes. Therefore, after the number of connected sound boxes is determined, the mounting position of the sound box can be determined according to the sound box orientation angle. It can be determined whether the mounting position of the sound box is far or near according to the distance between the listener and the sound box.

Using two sound boxes as an example, the number of currently connected sound boxes is detected as 2, and the system selects a binaural output mode. In this mode, the algorithm employs a binaural virtual playback model, where PL and PR represent pressure arriving at a left ear and a right ear respectively, H represents a transmission function of the ear corresponding to each sound box, HLL represents a transmission function of direct sound that is emitted by a left sound box and arrives at the left ear, and HRL represents a transmission function of direct sound that is emitted by the left sound box and arrives at the right ear. Using a playback model of two sound boxes as an example, the sound pressure of the left ear and the right ear is calculated according to the following formula:

$$[ \begin{matrix}{P}_{L} \\ {P}_{R}\end{matrix} ] = [ \begin{matrix}{H}_{L} \\ {H}_{R}\end{matrix} ] {E}_{0}$$

where, E₀ represents an input signal.

The orientation angle and the distance between the listener and the sound box are loaded into the sound field model according to the detected orientation angle of the sound box. As shown in FIG. 4, the distances from each sound box to the left ear and the right ear of the listener can be obtained according to the distances from the two sound boxes to the listener, a diameter of the human head, and orientation angles of the two sound boxes. The sound field transmission function is adjusted according to the distance and the input sound signal to ensure that a strength difference, a timbre difference, a time difference, and a phase difference between the left ear and the right ear are stable and controllable. For example, the time difference between the left ear and the right ear is controlled to create an effect that the sound is transmitted from a specified direction.

In step S104, a digital audio signal is adjusted according to the sound field transmission function, and the adjusted digital audio signal is output.

The digital audio signal is adjusted according to the sound field transmission function, so that the output audio signal corresponds to the position of the listener and the mounting position of the sound box, which helps effectively control the timbre difference, strength difference, time difference and phase difference of the sound heard by the listener and brings better effects.

In the embodiment of the present invention, a sound field model is created by detecting the number of connected sound boxes, and the sound field transmission function is adjusted according to the sound box orientation angle and the distance between the sound box and the listener, so that the listener adjusts the sound field transmission function according to the position of the listener and the position of the sound box, better acoustic effects are achieved according to specific conditions, and higher acoustic adaptability is achieved.

### Embodiment 2

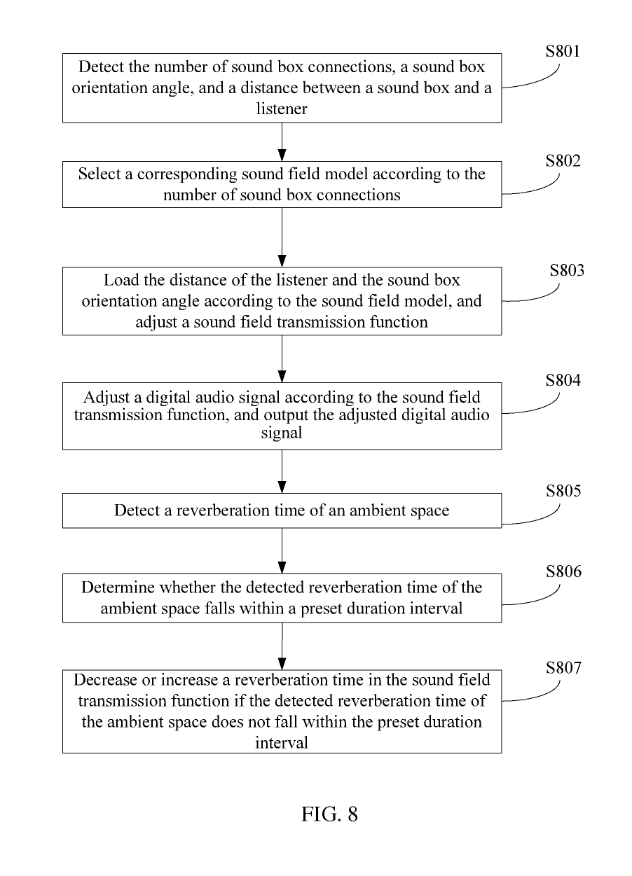

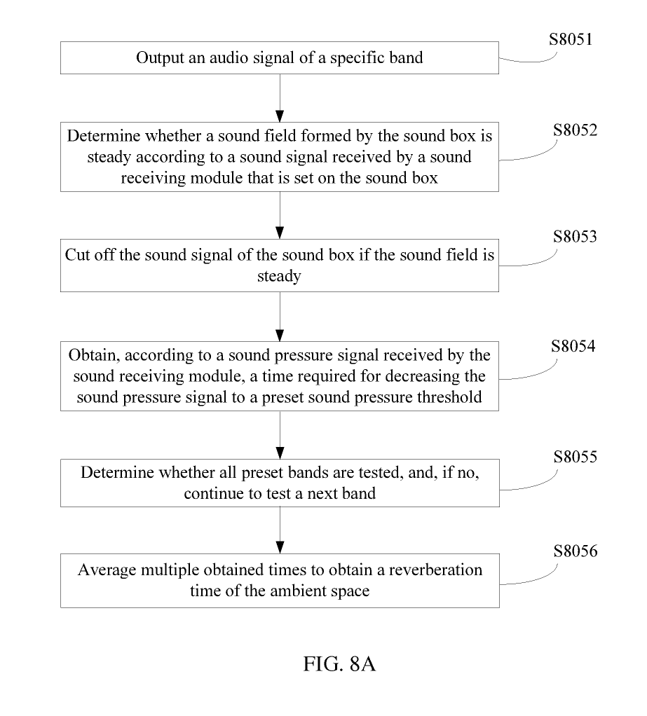

FIG. 8 is a schematic flowchart of sound effect adjustment according to Embodiment 2 of the present invention, as detailed below:

In step S801, the number of connected sound boxes, a sound box orientation angle, and a distance between a sound box and a listener are detected.

In step S802, a corresponding sound field model is selected according to the number of connected sound boxes.

In step S803, the distance between the sound box and the listener and the sound box orientation angle are loaded according to the sound field model, and a sound field transmission function is adjusted.

In step S804, a digital audio signal is adjusted according to the sound field transmission function, and the adjusted digital audio signal is output.

Steps S801-S804 are the same as steps S101-S104 in Embodiment 1, and are not repeated here any further.

In step S805, a reverberation time of an ambient space is detected.

Specifically, FIG. 8A is a schematic diagram of detecting the reverberation time of the ambient space, which may include the following steps:

S8051. Output an audio signal of a specific band.

S8052. Determine whether a sound field formed by the sound box is steady according to a sound signal received by a sound receiving module that is set on the sound box.

The sound receiving module that is set on the sound box may be a device such as a microphone, and can obtain a response signal of the sound. The sound receiving module may be set on all N sound boxes, and N obtained sound signals are averaged.

Whether the sound field is steady may be determined according to the sound pressure of the received signal. If the received sound pressure value is steady within an interval (where the interval may be preset, such as 5 dB) in a specific time range (such as 2 seconds or 3 seconds), it indicates that the current sound field is steady.

S8053. Cut off the sound signal of the sound box if the sound field is steady.

The sound signal of the sound box is cut off by controlling output of the sound box adaptation apparatus.

S8054. Obtain, according to a sound pressure signal received by the sound receiving module, a time required for decreasing the sound pressure signal to a preset sound pressure threshold.

Timing begins when the sound signal of the sound box is cut off, and the strength of the sound pressure signal is detected. When the strength decreases to a preset sound pressure threshold such as 60 dB, the timing stops, and the obtained time value is the required time.

S8055. Determine whether all preset bands are tested, and, if not, continue to test a next band.

All the preset bands may be measured according to 1 octave such as 125 hertz (Hz), 250 Hz, 500 Hz, 1000 Hz, 2000 Hz, and 4000 Hz. On the sound box 1, the above bands are tested in turn.

S8056. Average multiple obtained times to obtain a reverberation time of the ambient space.

After the preset bands are measured, the obtained multiple measured values of the reverberation time are averaged to obtain the reverberation time of the ambient space.

In step S806, whether the detected reverberation time of the ambient space falls within a preset duration interval is determined.

In step S807, a reverberation time parameter value in the sound field transmission function is decreased or increased if the detected reverberation time of the ambient space does not fall within the preset duration interval.

If the reverberation time of the ambient space is long and greater than the preset duration interval, the reverberation time value in the sound field transmission function is decreased by using the sound box adaptation apparatus, so as to avoid fuzz of the ultimate sound; and, if the reverberation time of the ambient space is shorter than the preset duration interval, the reverberation time parameter value in the sound field transmission function is increased to avoid shriveling of the ultimate sound.

The embodiment of the present invention differs from Embodiment 1 in the additional test of the reverberation time of the ambient space, and further improves adaptability of the sound box to the ambient space based on the position of the sound box and the position of the listener, and achieves a better sound effect. In addition, the entire operation process requires no professionals to perform debugging, and the operation is convenient and simple.

### Embodiment 3

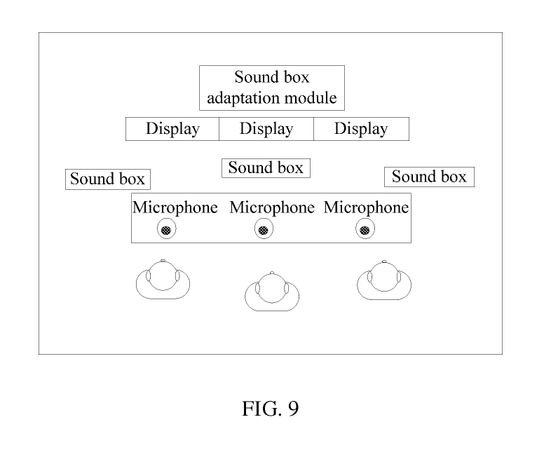

FIG. 9 is a schematic structural diagram of an audio conference to which a sound effect adjustment method is applied according to Embodiment 3 of the present invention, as detailed below:

In a conference room shown in FIG. 9, there are multiple microphones for speaking, multiple members that attend a conference, and multiple sound boxes. On the basis of Embodiment 1, the embodiment of the present invention further includes the following steps:

In step 901, an audio signal that is input by a microphone on which position information is set is received.

When the microphone gets connected, corresponding label information may be added to the position information of the microphone, and stored in the sound box adaptation apparatus.

In step 902, the position information of the sound box is obtained.

The user may input the corresponding position information of the sound box according to an on-site sound box connection status, or a positioning apparatus may be installed on each sound box to confirm the position.

In step 903, the sound field transmission function is adjusted according to position information of the microphone.

The sound field transmission function of the sound box may be further adjusted according to not only the position of the listener, the number of connected sound boxes, and the sound box orientation angle on the site, but also the position parameter input by the microphone, so that the orientation on the site is more compliant with site requirements.

### Embodiment 4

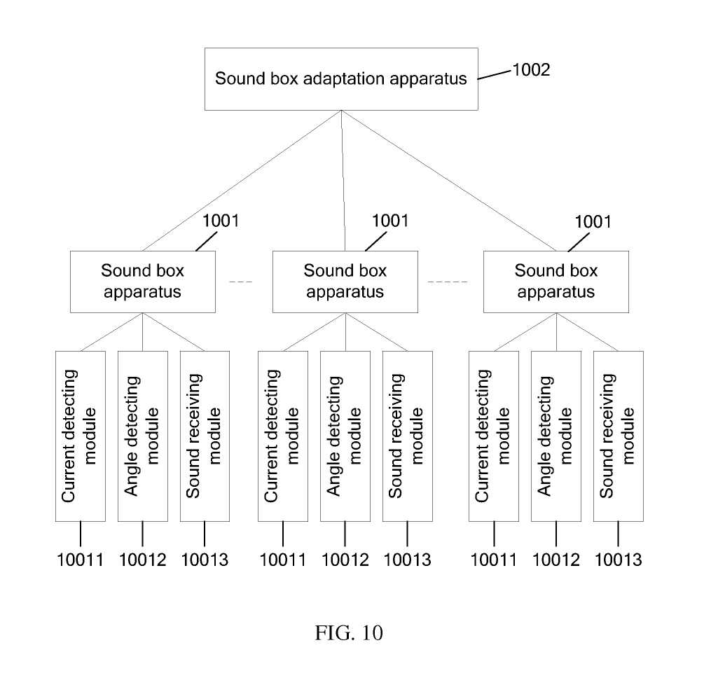

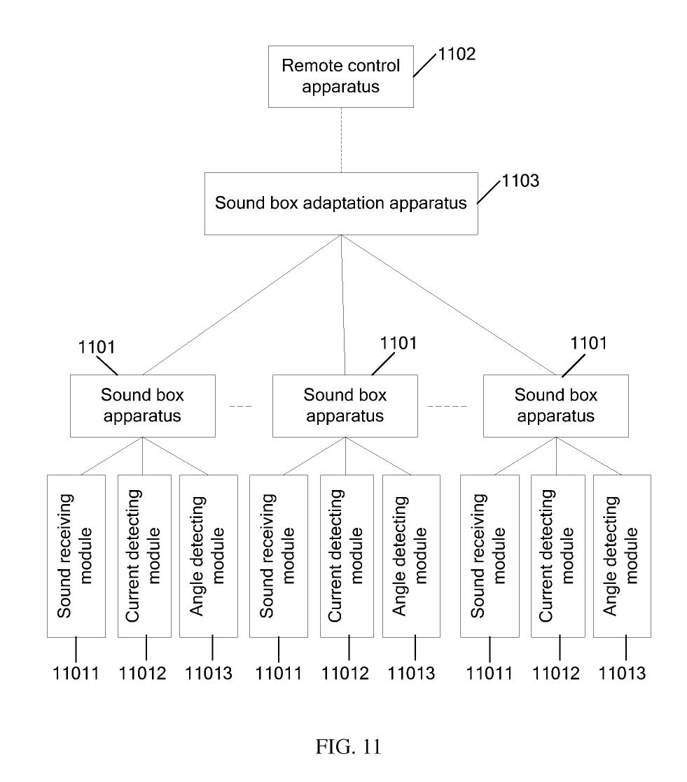

FIG. 10 is a sound effect adjustment system according to Embodiment 4 of the present invention, as detailed below:

The system includes a sound box apparatus 1001, where a current detecting module 10011 and an angle detecting module 10012 are set on the sound box apparatus to detect a current signal that flows through a sound box and an angle signal of the sound box respectively; and a sound box adaptation apparatus 1002 configured to: receive the current signal, the angle signal of the sound box, and the distance signals of the listener, calculate the number of corresponding connected sound boxes, a sound box orientation angle, and the distance between the sound box and the listener, select a corresponding sound field model according to the number of connected sound boxes, load the distance between the sound box and the listener and the sound box orientation angle according to the sound field model and adjust a sound field transmission function, and adjust a digital audio signal according to the sound field transmission function and output the adjusted digital audio signal.

The sound box apparatus 1001 is connected to a sound box adaptation module in a wired or wireless manner.

In order for the sound box to achieve a better reverberation effect, the sound box apparatus 1001 further includes a sound receiving module 10013 configured to receive a sound signal; and the sound box adaptation apparatus 1002 is configured to: output an audio signal of a specific band, receive the sound signal of the sound receiving module 10013 and determine whether a sound field formed by the sound box is steady, cut off the sound signal of the sound box if the sound field is steady, and obtain, according to a sound pressure signal received by the sound receiving module 10013, a time required for decreasing the sound pressure signal to a preset sound pressure threshold, determine whether all preset bands are tested, and, if not, continue to test a next band, and average multiple obtained times to obtain a reverberation time of the ambient space, and decrease or increase a reverberation time parameter value in the sound field transmission function if determining that the reverberation time of the ambient space does not fall within the preset duration interval.

### Embodiment 5

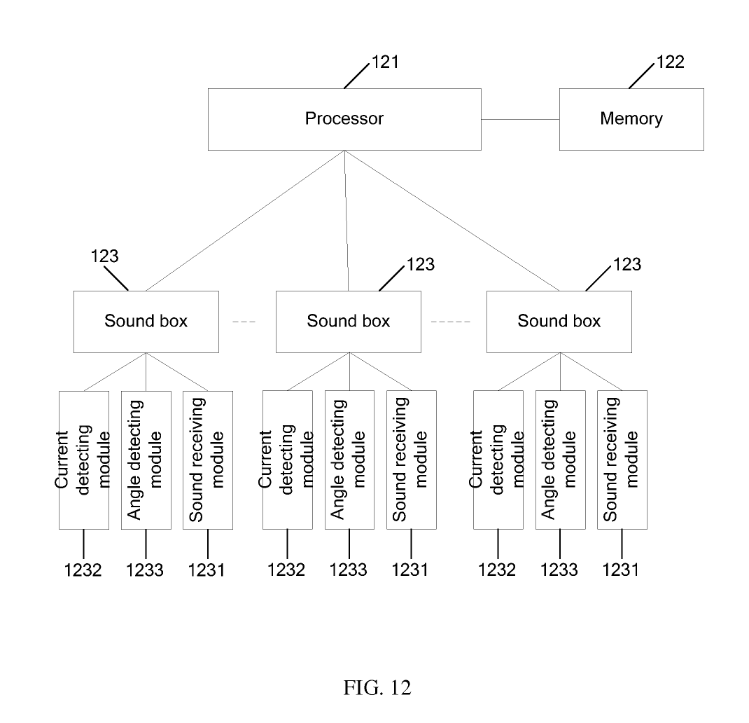

FIG. 11 is a sound effect adjustment system according to Embodiment 5 of the present invention, as detailed below:

The sound effect adjustment system in the embodiment of the present invention includes a sound box apparatus 1101, where a sound receiving module 11011, a current detecting module 11012, and an angle detecting module 11013 are set on the sound box apparatus to detect a sound signal, a current signal, and an angle signal of a sound box respectively; a remote control apparatus 1102 configured to receive a remote control instruction, and send an ultrasonic wave or a sound wave that is receivable by the sound receiving module of the sound box apparatus 1101; and a sound box adaptation apparatus 1103 configured to receive the sound signal, the current signal, and the angle signal of the sound box, calculate a distance between a corresponding sound box and a listener, the number of connected sound boxes, and a sound box orientation angle, select a corresponding sound field model according to the number of connected sound boxes, load the distance between the sound box and the listener and the sound box orientation angle according to the sound field model and adjust a sound field transmission function, and adjust a digital audio signal according to the sound field transmission function and output the adjusted digital audio signal.

In order for the sound box to achieve a better reverberation effect, the sound receiving module 11011 is further configured to receive a sound signal; and the sound box adaptation apparatus 1102 is configured to: output an audio signal of a specific band, receive the sound signal of the sound receiving module 11011 and determine whether a sound field formed by the sound box is steady, cut off the sound signal of the sound box if the sound field is steady, and obtain, according to a sound pressure signal received by the sound receiving module 11011, a time required for decreasing the sound pressure signal to a preset sound pressure threshold, determine whether all preset bands are tested, and, if not, continue to test a next band, and average multiple obtained times to obtain a reverberation time of the ambient space, and decrease or increase a reverberation time parameter value in the sound field transmission function if determining that the reverberation time of the ambient space does not fall within the preset duration interval.

The embodiment of the present invention differs from Embodiment 4 in that: the remote control apparatus 1102 of the listener sends a sound wave or ultrasonic wave, and the sound receiving module 11011 determines the distance between the listener and the sound box apparatus.

### Embodiment 6

As shown in FIG. 12, a sound effect adjustment system provided in Embodiment 6 of the present invention includes a processor 121, a memory 122, and a sound box 123, and includes a sound receiving module 1231, a current detecting module 1232, and an angle detecting module 1233 that are installed on the sound box.

The processor 121 is configured to execute programs.

In Embodiment 4 of the present invention, the programs may include program code, where the program code includes computer operation instructions.

The processor 121 may be a central processing unit (CPU) or one or more integrated circuits configured to implement the embodiments of the present invention.

The memory 122 is configured to store programs.

The memory 122 may include a random-access memory (RAM), and may further include a non-volatile random-access memory (NVRAM).

The sound box 123 is configured to convert an audio signal into a sound signal, and the current detecting module 1232, the angle detecting module 1233, and the sound receiving module 1231 are respectively configured to detect a current signal that flows through a sound box, an angle signal of the sound box, and a distance signal of a listener. The sound receiving module 1231 may collaborate with the remote control apparatus 124 to detect the distance between the listener and the sound box.

When adjusting sound effects, the processor 121 is configured to execute programs stored in the memory 122 to make the sound effect adjustment system execute the following method: the processor 121 detects the number of connected sound boxes, a sound box orientation angle, and a distance between a sound box and a listener; the processor 121 selects a corresponding sound field model according to the number of connected sound boxes; the processor 121 loads the distance between the sound box and the listener and the sound box orientation angle according to the sound field model, and adjusts a sound field transmission function; and the processor 121 adjusts a digital audio signal according to the sound field transmission function and outputs the adjusted digital audio signal.

### Embodiment 7

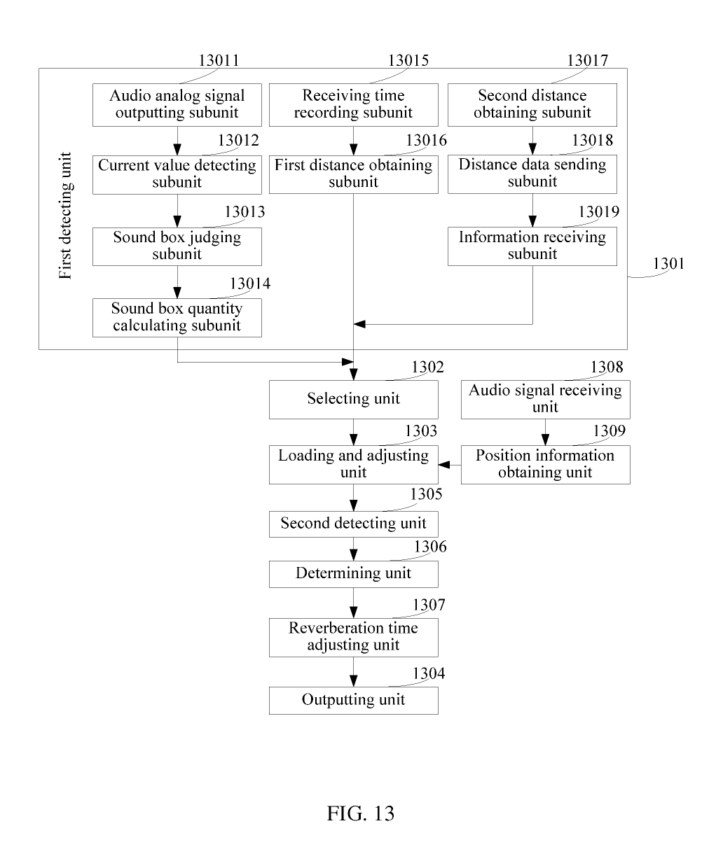

FIG. 13 is a structural block diagram of a sound effect adjustment apparatus according to Embodiment 7 of the present invention, as detailed below:

The sound effect adjustment apparatus in the embodiment of the present invention includes a first detecting unit 1301, a selecting unit 1302, a loading and adjusting unit 1303, and an outputting unit 1304, where: the first detecting unit 1301 is configured to detect the number of connected sound boxes, a sound box orientation angle, and a distance between a sound box and a listener; the selecting unit 1302 is configured to select a corresponding sound field model according to the number of connected sound boxes; the loading and adjusting unit 1303 is configured to load the distance between the sound box and the listener and the sound box orientation angle according to the sound field model, and adjust a sound field transmission function; and the outputting unit 1304 is configured to adjust a digital audio signal according to the sound field transmission function and output the adjusted digital audio signal.

The detecting unit 1301 includes: an audio analog signal outputting subunit 13011 configured to output an audio analog signal at all sound box interfaces; a current value detecting subunit 13012 configured to detect a value of a current that is series connected in a sound box connection line and passes through a current detecting module; a sound box determining subunit 13013 configured to: if the current value reaches a preset value, determine that the sound box in the connection line is available; a sound box quantity calculating subunit 13014 configured to calculate the number of all available sound boxes; a receiving time recording subunit 13015 configured to record a sound wave or ultrasonic wave signal sent by the listener and received by a sound receiving module that is set on each sound box, and record a transmission time; a first distance obtaining subunit 13016 configured to obtain the distance between the listener and the sound box according to the time at which the sound wave or ultrasonic wave is received; a second distance obtaining subunit 13017 configured to obtain data of the distance between the listener and the sound box in real time, where the data is received by an infrared rangefinder that is set on a sound box device; a distance data sending subunit 13018 configured to send the obtained distance data to an output device; and an information receiving subunit 13019 configured to receive distance information confirmed by the listener or distance information selected by the listener.

To further improve results of sound effect adjustment, the sound effect adjustment apparatus may further include: a second detecting unit 1305 configured to detect a reverberation time of an ambient space; a determining unit 1306 configured to determine whether the detected reverberation time of the ambient space falls within a preset duration interval; and a reverberation time adjusting unit 1307 configured to decrease or increase a reverberation time parameter value in the sound field transmission function if the detected reverberation time of the ambient space does not fall within the preset duration interval.

To make the sound effect correspond to an audio input position, the apparatus may further include: an audio signal receiving unit 1308 configured to receive an audio signal that is input by a microphone on which position information is set; and a position information obtaining unit 1309 configured to obtain position information of the sound box, where the loading and adjusting unit 1303 is further configured to adjust the sound field transmission function according to position information of the microphone.

The embodiment of the present invention corresponds to the foregoing method embodiment, which is not repeated here any further.

The foregoing descriptions are merely exemplary embodiments of the present invention, but are not intended to limit the present invention. Any modification, equivalent replacement, or improvement made within the spirit and principle of the present invention shall fall within the protection scope of the present invention.

What is claimed is:

1. A sound effect adjustment method, comprising:
detecting a number of connected sound boxes, a sound box orientation angle, and a distance between a sound box and a listener;
selecting a corresponding sound field model according to the number of connected sound boxes;
loading the distance between the sound box and the listener and the sound box orientation angle according to the sound field model, and adjusting a sound field transmission function; and
adjusting a digital audio signal according to the sound field transmission function and outputting the adjusted digital audio signal.

2. The method according to claim 1, further comprising:
detecting a reverberation time of an ambient space;
determining whether the detected reverberation time of the ambient space falls within a preset duration interval; and
decreasing or increasing a reverberation time parameter value in the sound field transmission function when the detected reverberation time of the ambient space does not fall within the preset duration interval.

3. The method according to claim 2, wherein detecting the reverberation time of the ambient space specifically comprises:
outputting an audio signal of a specific band;
determining whether a sound field formed by the sound box is steady according to a sound signal received by a sound receiving module that is set on the sound box;
cutting off the sound signal of the sound box when the sound field is steady;
obtaining, according to a sound pressure signal received by the sound receiving module, a time required for decreasing the sound pressure signal to a preset sound pressure threshold;
determining whether all preset bands are tested, and continuing to test a next band when all preset bands are not tested; and
averaging multiple obtained times to obtain a reverberation time of the ambient space.

4. The method according to claim 3, wherein the preset sound pressure threshold is 60 decibels (dB).

5. The method according to claim 1, wherein detecting the number of connected sound boxes specifically comprises:
outputting an audio analog signal at all sound box interfaces;
detecting a value of a current that is series connected in a sound box connection line and passes through a current detecting module;
determining that the sound box in the connection line is available when the current value reaches a preset value; and
calculating the number of all available sound boxes.

6. The method according to claim 1, wherein detecting the sound box orientation angle specifically is obtaining, by an angle detecting module that is set on each sound box and oriented toward the same direction as an opening direction of the sound box, data of the sound box orientation angle.

7. The method according to claim 1, wherein detecting the distance between the sound box and the listener specifically comprises:
recording a sound wave or ultrasonic wave signal sent by the listener and received by a sound receiving module that is set on each sound box, and recording a transmission time; and
obtaining the distance between the listener and the sound box according to a time at which the sound wave or ultrasonic wave signal is received.

8. The method according to claim 1, wherein detecting the distance between the sound box and the listener specifically comprises:
obtaining data of the distance between the listener and the sound box in real time, wherein the data is received by an infrared rangefinder that is set on a sound box device;
sending the obtained distance data to an output device; and
receiving distance information confirmed by the listener or distance information selected by the listener.

9. The method according to claim 1, further comprising:
receiving an audio signal that is input by a microphone on which position information is set; and
obtaining position information of the sound box,
wherein loading the distance between the sound box and the listener and the sound box orientation angle according to the sound field model and adjusting a sound field transmission function comprises adjusting the sound field transmission function according to position information of the microphone.

10. A sound effect adjustment apparatus, comprising:
a first detecting unit configured to detect a number of connected sound boxes, a sound box orientation angle, and a distance between a sound box and a listener;
a selecting unit configured to select a corresponding sound field model according to the number of connected sound boxes;
a loading and adjusting unit configured to load the distance between the sound box and the listener and the sound box orientation angle according to the sound field model, and adjust a sound field transmission function; and
an outputting unit configured to adjust a digital audio signal according to the sound field transmission function and output the adjusted digital audio signal.

11. The apparatus according to claim 10, further comprising:
a second detecting unit configured to detect a reverberation time of an ambient space;
a determining unit configured to determine whether the detected reverberation time of the ambient space falls within a preset duration interval; and
a reverberation time adjusting unit configured to decrease or increase a reverberation time parameter value in the sound field transmission function when the detected reverberation time of the ambient space does not fall within the preset duration interval.

12. The apparatus according to claim 11, wherein the second detecting unit specifically comprises:
an audio signal outputting subunit configured to output an audio signal of a specific band;
a sound field steadiness determining subunit configured to determine whether a sound field formed by the sound box is steady according to a received sound signal;
a sound signal cutoff subunit configured to cut off the sound signal of the sound box when the sound field is steady;
an obtaining subunit configured to obtain, according to a sound pressure signal received by the sound receiving module, a time required for decreasing the sound pressure signal to a preset sound pressure threshold;
a first determining subunit configured to determine whether all preset bands are tested, and continue to test a next band when all preset bands are not tested; and
a reverberation time obtaining subunit configured to average multiple obtained times to obtain a reverberation time of the ambient space.

13. The apparatus according to claim 12, wherein the preset sound pressure threshold is 60 decibels (dB).

14. The apparatus according to claim 10, wherein the detecting unit comprises:
an audio analog signal outputting subunit configured to output an audio analog signal at all sound box interfaces;
a current value detecting subunit configured to detect a value of a current that is series connected in a sound box connection line and passes through a current detecting module;
a sound box determining subunit configured to determine that the sound box in the connection line is available when the current value reaches a preset value; and
a sound box quantity calculating subunit configured to calculate the number of all available sound boxes.

15. The apparatus according to claim 10, wherein the detecting unit comprises:
a receiving time recording subunit configured to record a sound wave or ultrasonic wave signal sent by the listener and received by a sound receiving module that is set on each sound box, and record a transmission time; and
a first distance obtaining subunit configured to obtain the distance between the listener and the sound box according to the time at which the sound wave or ultrasonic wave is received.

16. The apparatus according to claim 10, wherein the detecting unit comprises:
a second distance obtaining subunit configured to obtain data of the distance between the listener and the sound box in real time, wherein the data is received by an infrared rangefinder that is set on a sound box device;
a distance data sending subunit configured to send the obtained distance data to an output device; and
an information receiving subunit configured to receive distance information confirmed by the listener or distance information selected by the listener.

17. The apparatus according to claim 10, wherein the apparatus further comprises:
an audio signal receiving unit configured to receive an audio signal that is input by a microphone on which position information is set; and
a position information obtaining unit configured to obtain position information of the sound box,
wherein the loading and adjusting unit is further configured to adjust the sound field transmission function according to position information of the microphone.

18. A sound effect adjustment system, comprising:
a sound box apparatus, wherein a current detecting module, an angle detecting module, and an infrared rangefinder are set on the sound box apparatus to detect a current signal that flows through a sound box, detect an angle signal of the sound box, and detect a distance signal of a listener, respectively; and
a sound box adaptation apparatus configured to receive the current signal, the angle signal of the sound box, and the distance signal of the listener, calculate a number of corresponding connected sound boxes, a sound box orientation angle, and the distance between the sound box and the listener, select a corresponding sound field model according to the number of connected sound boxes, load the distance between the sound box and the listener and the sound box orientation angle according to the sound field model and adjust a sound field transmission function, and adjust a digital audio signal according to the sound field transmission function and output the adjusted digital audio signal.

19. The system according to claim 18, wherein the sound box apparatus further comprises a sound receiving module configured to receive a sound signal, and wherein the sound box adaptation apparatus is configured to output an audio signal of a specific band, receive the sound signal of the sound receiving module and determine whether a sound field formed by the sound box is steady, cut off the sound signal of the sound box when the sound field is steady, and obtain, according to a sound pressure signal received by the sound receiving module, a time required for decreasing the sound pressure signal to a preset sound pressure threshold, determine whether all preset bands are tested, and continue to test a next band when all preset bands are not tested, and average multiple obtained times to obtain a reverberation time of the ambient space, and decrease or increase a reverberation time parameter value in the sound field transmission function when determining that the reverberation time of the ambient space does not fall within the preset duration interval.

20. A sound effect adjustment system, comprising:
a sound box apparatus, wherein a sound receiving module, a current detecting module, and an angle detecting module are set on the sound box apparatus to detect a sound signal, a current signal, and an angle signal of a sound box respectively;
a remote control apparatus configured to receive a remote control instruction, and send an ultrasonic wave or a sound wave that is receivable by the sound receiving module of the sound box apparatus; and
a sound box adaptation apparatus configured to receive the sound signal, the current signal, and the angle signal of the sound box, calculate a distance between a corresponding sound box and a listener, the number of connected sound boxes, and a sound box orientation angle, select a corresponding sound field model according to a number of connected sound boxes, load the distance between the sound box and the listener and the sound box orientation angle according to the sound field model and adjust a sound field transmission function, and adjust a digital audio signal according to the sound field transmission function and output the adjusted digital audio signal.
